(19) United States
(12) Patent Application Publication
(10) Pub. No.: US 2012/0318632 A1
(43) Pub. Date: Dec. 20, 2012

(54) FREE COASTER HUB FOR A BICYCLE

(75) Inventor: Terence Gregory Blake, Madison, WI (US)

(73) Assignee: Pacific Cycle, LLC

(21) Appl. No.: 13/523,177

(22) Filed: Jun. 14, 2012

Related U.S. Application Data
(60) Provisional application No. 61/496,825, filed on Jun. 14, 2011.

(51) Int. Cl. F16D 41/24

(52) U.S. Cl. 192/41 R

(57) ABSTRACT

A coaster-style hub functions as a freewheel and accommodates a 9 tooth sprocket. A throw out bearing is used to allow the clutch to spin freely when the driver and sprocket are rotated in a backward direction. The driver and sprocket can be formed as a single piece.

### CROSS-REFERENCE TO RELATED APPLICATIONS

This application claims the benefit of and priority to U.S. provisional application Ser. No. 61/496,825 filed Jun. 14, 2011, which is incorporated herein by reference, under 35 U.S.C. §119(e).

### BACKGROUND OF THE INVENTION

The present invention relates generally to bicycle hubs. In particular, the present invention relates to a free coaster hub for a bicycle.

In recent years a smaller drive train for bicycles has become popular for various reasons, including weight, strength, clearance and aesthetics. Smaller drive sprockets and a shorter chain equates to lower weight, and a smaller sprocket diameter is stronger, less likely to bend or deform, and gives more clearance from ground to drive train. Using current designs of a threaded-on freewheel, it is not possible to use a drive sprocket smaller than a standard fourteen tooth rear sprocket and maintain the space needed for bearings and a ratchet mechanism. One design used to accommodate smaller drive sprockets is a “cassette” style rear hub, which incorporates the ratchet mechanism inside the hub body to leave enough clearance outside the hub body for a smaller nine tooth drive sprocket and bearing to fit over the axle. While the cassette design solves certain problems, it is costly and has many complicated parts. Another common hub design is a “coaster brake” hub, which does not include a ratcheting mechanism and allows a rider to activate the brakes by pedaling backwards. Coaster brake hubs are simple and robust, but lack the ability to freewheel that is desired by many bicycle riders.

Accordingly, a need exists for an improved hub design that solves these and other deficiencies in the prior art. Of course, the present invention is not limited to bicycles, but may be used in other applications where similar performance capabilities are required.

### SUMMARY OF THE INVENTION

The present invention provides a hub design that is cost-effective, provides improved functionality, and eliminates certain of the deficiencies inherent in existing designs. Various embodiments of the present invention overcome many of the disadvantages associated with the prior art. To overcome these disadvantages, the applicant has developed a new hub based on the traditional “coaster brake” with some significant modifications.

In one embodiment, a bicycle hub includes an axle disposed through a hub shell and a clutch positioned about the axle and within the hub shell. The clutch interacts with a throw out bearing and a driver with a sprocket. The clutch engages the hub shell when the driver is rotated in a forward direction, and the throw out bearing causes the clutch to disengage and spin freely when the driver is rotated in a backward direction. The spacing between engagement of the clutch in a forward direction and disengagement of the clutch in a backward direction is preferably less than 15 degrees but other designs could be accomplished. The sprocket is preferably a 9 tooth sprocket, and the driver and sprocket are preferably formed as a single piece, but other configurations are possible.

One embodiment includes a brake mechanism much like a traditional coaster brake design except that the driver and sprocket are formed as a unitary piece. In another embodiment, the brake mechanism is deleted, thereby creating a forward only design, similar to a freewheel, but with the additional benefit of being a “free coaster,” which is a “clutch” instead of a ratchet. The advantage of a clutch is that it will not engage when the bicycle is rolled backwards because it requires forward pedaling. A traditional freewheel will engage when the bicycle is rolled backwards, forcing the cranks to turn backwards. This may be unwanted during certain maneuvers. In place of the brake mechanism, this design uses a “throw out bearing” (similar to an automobile clutch). This allows the pedals to be rotated backwards indefinitely, like a freewheel, by causing the clutch mechanism to spin freely while turning in reverse.

Additionally, the spacing between forward engagement of the clutch and free spinning in reverse is shortened to allow a shorter engagement degree (which is the preferred design). In a standard coaster brake, the engagement is approximately 80 degrees allowing enough room for the brake to engage in reverse. In a freewheel, the engagement degree varies, but is generally less than 15 degrees. In this configuration, the spacing change is also set to engage in less than 15 degrees, keeping the design in line with competing freewheel products.

Lastly, because of the inherent design of the “driver” of a coaster brake hub, typically the sprocket is a separate part and is held in place with a circlip. In this design, the driver and sprocket may be forged as one piece but may also be separate pieces. A one piece design simplifies the design and assembly and allows the present invention to accommodate the smaller 9 tooth sprocket. A one piece driver and sprocket can also be used in connection with a traditional coaster brake hub to accommodate a smaller 9 tooth sprocket.

The present invention uses the cost advantages of the traditional coaster brake hub design combined with these new modifications to create a cost effective way to use a 9 tooth freewheeling hub on a bicycle. It also adds beneficial features not possible in traditional ratcheting designs, be they freewheel or cassette.

While certain possible applications and advantages of the present invention have been described herein, many other applications are possible and references to use in connection with a particular application should not be deemed to limit the uses of the present invention. The terms used herein should not be interpreted as being limited to specific forms, shapes, or compositions. Rather, the parts may have a wide variety of shapes and forms and may be composed of a wide variety of materials.

### BRIEF DESCRIPTION OF THE DRAWINGS

FIG. 1 is a partially cross-sectional top view illustrating a coaster hub using a one piece driver and 9 tooth sprocket in accordance with the present invention implemented in a conventional coaster brake system;

FIG. 2 is a left side view of the coaster hub shown in FIG. 1;

FIG. 3 is an partially cross-sectional top view illustrating a 9 tooth free coaster hub in accordance with the present invention with no coaster braking;

FIG. 4 is a left side view of the coaster hub shown in FIG. 3; and

FIG. 5 is an exploded perspective view of the 9 tooth free coaster hub shown in FIG. 3.

### DETAILED DESCRIPTION OF THE PREFERRED EMBODIMENTS

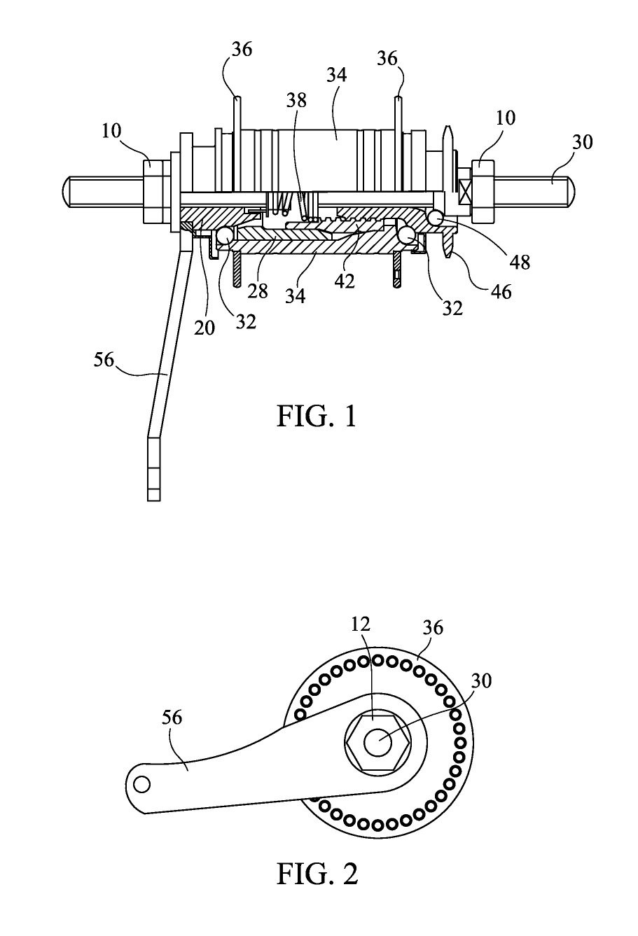

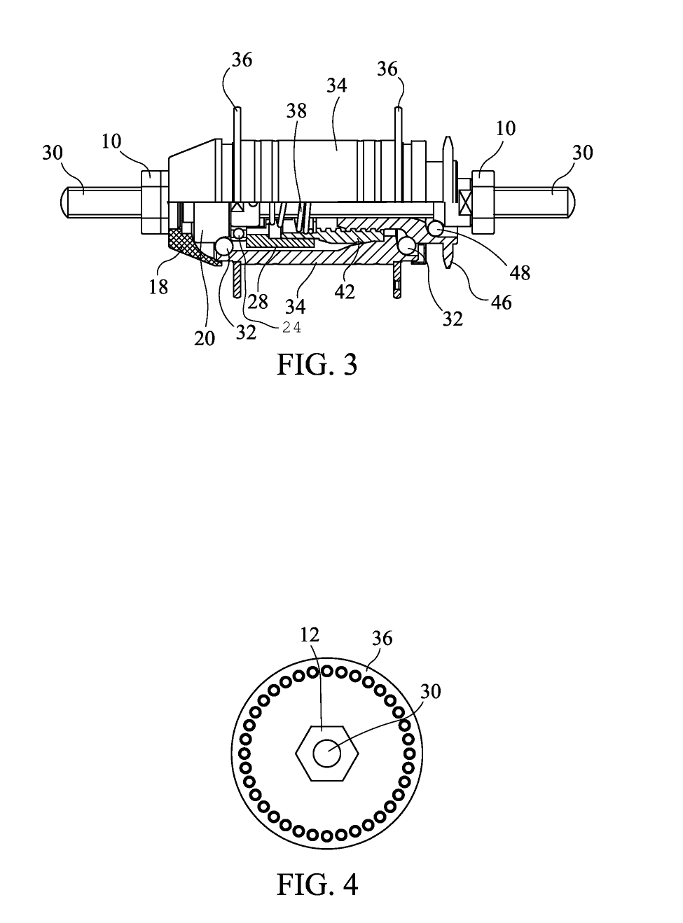

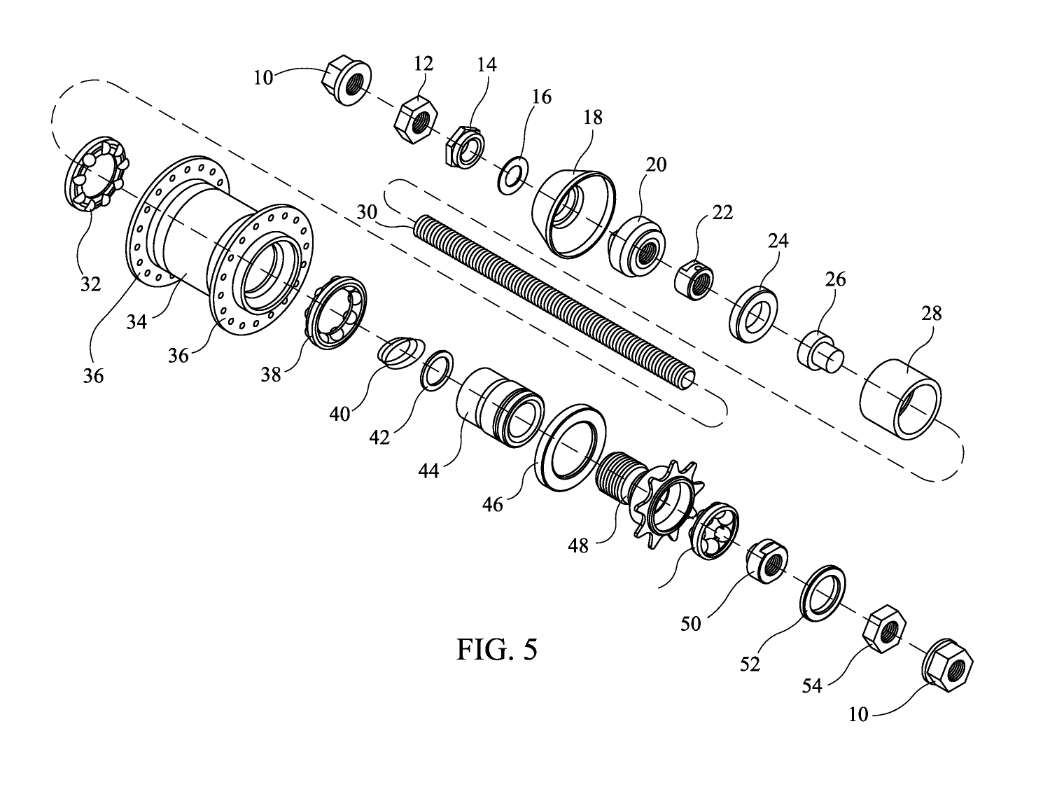

Referring now to the drawings, two embodiments of a coaster hub in accordance with the invention are shown. FIGS. 1 and 2 illustrate a unitary driver/sprocket assembly in accordance with the invention used in a conventional coaster brake system. FIGS. 3-5 illustrate a 9 tooth free coaster hub in accordance with the invention without a coaster brake. The exploded view in FIG. 3 shows the following component parts in detail:

| Part No. | Description |
|---|---|
| 10 | outer axle nut (2 pieces) |
| 12 | inner lock nut left side |
| 14 | inner lock nut 2 left side |
| 16 | washer |
| 18 | dust cap |
| 20 | left side outer bearing cone |
| 22 | inside lock nut |
| 24 | throw out bearing |
| 26 | spring engagement spacer |
| 28 | clutch spacer |
| 30 | axle |
| 32 | outer bearings (2 pieces - left and right sides) |
| 34 | hub shell |
| 36 | flange of hub shell |
| 38 | clutch spring |
| 40 | spring washer |
| 42 | clutch |
| 44 | clutch race (part of hub shell 34) |
| 46 | 9 tooth once piece driver and sprocket |
| 48 | driver bearing |
| 50 | right side bearing cone |
| 52 | right side dust cap |
| 54 | inner lock nut right |
| 56 | coaster brake arm |

The embodiment of the present invention shown in FIGS. 3-5 is a coaster-style hub including an axle 30 disposed through a hub shell 34, and a driver/sprocket 46 interacting with a clutch 42. The clutch 42 further includes a clutch spring 38 and spring washer 40. In this embodiment, instead of a brake mechanism (see FIGS. 1-2 and coaster brake arm 56), the present invention includes a throw out bearing 24 as shown, which is similar to the throw out bearing used in an automobile clutch. The throw out bearing 24 allows the pedals to be rotated backwards indefinitely, like a freewheel, by disengaging the clutch 42 from the hub shell 34 and causing the clutch mechanism 42 to spin freely while turning in reverse. The use of the throw out bearing 24 in a coaster-style hub creates a freewheel in that it becomes a forward only design, but it differs from a traditional freewheel in that it functions as a clutch instead of a ratchet. Unlike freewheel designs using a ratchet, the clutch design will not allow engagement of the clutch 42 when the bicycle is rolled backwards because engagement requires forward pedaling.

The embodiment of the present invention shown in FIGS. 3-5 also includes a spring engagement spacer 26 and a clutch spacer 28, which have been designed to shorten the spacing between forward engagement of the clutch 42 and free spinning in reverse. In a standard coaster brake, the engagement is approximately 80 degrees to allow enough room for the brake to engage in reverse. In a typical freewheel, the engagement is generally less than 15 degrees. The spacing change for the embodiment shown is also set to engage in less than 15 degrees, keeping the design in line with competing freewheel products.

The driver/sprocket 46 is preferably a driver and sprocket forged as one piece, as shown in FIG. 3. The use of a one piece driver and sprocket 46 simplifies the design and assembly and allows the design to accommodate the smaller 9 tooth sprocket. As shown in FIGS. 1-2, the driver/sprocket 46 can also be used in connection with a conventional coaster brake hub to accommodate a smaller 9 tooth sprocket, resulting in the improved coaster brake design shown.

Many different materials can be used for the various components, including metals, composites and plastics. The hub may have other applications aside from those specifically described herein. Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A hub for a bicycle, the hub comprising:
an axle disposed through a hub shell;
a clutch positioned about the axle and within the hub shell, the clutch interacting with a throw out bearing and a driver having an integral sprocket; and
wherein the clutch engages the hub shell when the driver is rotated in a forward direction so as to rotate the hub in a forward direction, and the throw out bearing causes the clutch to disengage such that the driver can spin freely when the driver is rotated in a backward direction.

2. The hub of claim 1, wherein the spacing between engagement of the clutch in a forward direction and disengagement of the clutch in a backward direction is less than 15 degrees.

3. The hub of claim 1, wherein the sprocket includes not more than 9 teeth.

4. The hub of claim 1, wherein the sprocket consists of 9 teeth.

5. A hub for a bicycle, the hub comprising:
an axle disposed through a hub shell;
a ratchet positioned within the hub shell, the ratchet interacting with a driver having an integral sprocket; and
wherein the ratchet engages the hub shell when the driver is rotated in a forward direction so as to rotate the hub in a forward direction.
